(19) United States
(12) Patent Application Publication
(10) Pub. No.: US 2012/0041807 A1
(43) Pub. Date: Feb. 16, 2012

(54) INCENTIVE-BASED SERVER COOPERATION SYSTEM, INCENTIVE-BASED SERVER COOPERATION METHOD AND INCENTIVE-BASED SERVER COOPERATION PROGRAM

(75) Inventors: Takushi Sogo, Tokyo (JP); Yutaka Nakanishi, Tokyo (JP); Tomohiro Chuzenji, Tokyo (JP)

(73) Assignee: NEC CORPORATION, Tokyo (JP)

(21) Appl. No.: 13/263,235

(22) PCT Filed: Apr. 6, 2010
(86) PCT No.: PCT/JP2010/056198

§ 371 Date: Oct. 27, 2011

(30) Foreign Application Priority Data
Apr. 8, 2009 (JP) 2009-093871

(51) Int. Cl. G06Q 30/02

(52) U.S. Cl. 705/14.16

(57) ABSTRACT

Only a limited number of service servers have been provided with the function of feeding back profits obtained through cooperation of multiple service servers to developers of cooperation modules and business entities running the service servers as incentives. In the present invention, a cooperation server for achieving cooperation between the service servers includes: a business entity data storage means for storing business entity data of the respective service servers; a cooperation module storage means for storing cooperation modules used for achieving cooperation between the service servers; a developer data storage means for storing developer data related to developers of the cooperation modules; a cooperation history storage means for storing cooperation history data of the cooperation modules; and an incentive settlement means for performing calculation of amounts of incentives and payment of the incentives.

### TECHNICAL FIELD

The present invention relates to an incentive-based server cooperation system, more particularly, to an incentive-based server cooperation system which achieves cooperation between service servers, such as web sites, through a network, such as the Internet.

### BACKGROUND ART

Nowadays, various business entities set up web sites over the Internet, and provide various online services. These online services may be often used individually; in some cases, however, multiple services are sequentially in a predetermined procedure.

For example, users of online services often perform a routine composed of searching for a shop they want to use for lunch in a restaurant search service, finding the nearest station by looking detailed shop information displayed on the screen, and then checking the train route from their homes to the nearest station. Accordingly, it would be convenient if the web browser is provided with the function of automatically performing this series of operations.

A web-site cooperation system which achieves cooperation between multiple web sites as thus described can be realized by using the add-on function of the web browser, for example.

### Example of Web Site Cooperation System

The system shown in FIG. 1 is one example of a web site cooperation system. This system extracts the name of the nearest station (character string) by analyzing a detailed shop page of a restaurant search site 101 and generates an appropriate query string (URL) to generate an add-on script 106 dedicated for recalling a train route search site 102. This add-on script 106 is installed onto a web browser 105 which operates on a client 104, such as a personal computer and a cell phone. By executing the add-on script 106 when shop information is displayed on the restaurant search site 101, it is possible to automatically establish connection to a train route search site 110 and to make a search for the train route to the nearest station.

By configuring the system as thus described, the user can realize the cooperation function desired by the user, independently of the intentions and conveniences of the entities who run the web sites.

In the web site cooperation system thus described, it is necessary to create a dedicated add-on script (cooperation module) for each combination of web sites to be cooperated, and the system convenience is improved by preparing as many cooperation module as possible. One approach for making many cooperation modules available may be to request the system users themselves to create cooperation modules and to share the modules among the users.

As in this example, inviting users from a certain web site to another web site may make some profit for the cooperation destination (or invitation destination) web site; this may lead to advertisement income or product sales. In such case, it may be advantageous that some incentives are paid to the business entity who runs the cooperation source (invitation source) web site or to the developer of the cooperation module used for the relevant cooperation from the business entity who runs the cooperation destination web site.

The affiliate is an existing scheme similar to this system.

### Example of Affiliate System

The system shown in FIG. 2 is one example of an affiliate system. In this system, a creator 208 creates an article about a blog site 201 which is an invitation source, and a public user browses the article on the web browser 205. In the article, a link to a commercial product of an online shopping site 202 is prepared, and an ID 206 embedded in the link for identifying the creator 208 is transmitted to the online shopping site 202 when the user clicks the link. When the commercial product is bought thereafter, an incentive is paid to the creator 208 from the incentive paying means 207 through a bank account and so on, by using this ID.

One possible scheme may be to apply this affiliate system to the aforementioned web site cooperation system, wherein an incentive is paid to a developer who creates and offers a cooperation module which achieves cooperation between web sites, in accordance with the number of times of uses of the cooperation module.

This approach effectively motivates many users to create various cooperation modules as developers, resulting in that the system convenience is improved by making many cooperation modules available.

### Problem of Conventional System

Conventionally, many web sites, except for some sites such as online shopping sites, do not support the incentive paying function in many cases, because the cost for supporting the incentive paying function is higher than the benefit offered by the incentive paying function. Accordingly, the above-described scheme requires the web sites to support the incentive paying function; however, only a limited number of web sites support the incentive paying function.

In addition, the above-described scheme requires a cooperation module for each web site; however, cooperation modules are not so often developed for many web sites which do not support the incentive paying function, because no incentives are paid to the developers of cooperation modules. Accordingly, it is unlikely that many web site cooperation functions are provided, resulting in poor user friendliness.

Furthermore, in the scheme in which a cooperation module is to be generated by a third party, it is uncertain in advance to the business entity of the cooperation source web site which cooperation destination web site is cooperated with which cooperation source web site. Accordingly, in order to receive an incentive which is possibly made available in future, it is necessary to register data necessary for receiving the incentive with respect to any possible business entities of cooperation destinations. This is unlikely at least in terms of the efficiency. Accordingly, in the conventional system, it is difficult for a business entity of a web site of a cooperation source to receive an incentive even if a business entity who runs a cooperation destination web site intends to pay an incentive to the cooperation source web site as well as the developer of a cooperation module.

### DISCLOSURE OF INVENTION

An objective of the present invention is to provide an incentive-based server cooperation system which eliminates the need for preparing the incentive paying function in a service server for which cooperation is to be achieved.

An incentive-based server cooperation system includes a plurality of service servers, a cooperation server which provides cooperation between the service servers and a client which uses the plurality of service servers. The cooperation server includes a business entity data storage means for storing business entity data related to business entities of the respective service servers; a cooperation module storage means for storing cooperation modules which cooperates the respective service servers; a developer data storage means for storing developer data related to developers of the cooperation modules; a cooperation history storage means for storing cooperation history data of the cooperation modules; and an incentive settlement means for calculating and paying an incentive amount by referring to the business entity data, the developer data and the cooperation history data. The client includes: a service information display means for displaying information acquired from the service servers; a cooperation module selection/execution means for selecting and executing the cooperation modules stored in the cooperation module storage means; and a cooperation history transmission means for notifying the cooperation history storage means of the executions of the cooperation modules.

The incentive-based server cooperation method of the present invention includes:

in a cooperation server which cooperates a plurality of service servers, storing business entity data related to business entity of the respective service servers in a business entity data storage means;

in the cooperation server, storing cooperation modules which achieve cooperation between the respective service servers in a cooperation module storage means;

in the cooperation server, storing developer data related to developers of the cooperation modules;

in the cooperation server, storing cooperation history data of the cooperation modules in a cooperation history storage means; and

in the cooperation server, calculating and paying an incentive amount by referring to the business entity data, the developer data and the cooperation history data.

The incentive-based server cooperation method further includes:

in a client which uses the service servers, displaying information acquired from the service servers on a display screen;

in the client, selecting and executing the cooperation modules stored in the cooperation module storage means; and

notifying the cooperation history storage means of the execution of the cooperation modules by the client.

The provision of the function of paying incentives for the cooperation server makes it possible for a business entity who runs a service server to pay an incentive only by registration to the cooperation server, eliminating the need for supporting the incentive paying function by the service server to be cooperated with.

### BRIEF DESCRIPTION OF DRAWINGS

FIG. 1 is a block diagram showing an exemplary configuration of a conventional web site cooperation system;

FIG. 2 is a block diagram showing an exemplary configuration of a conventional affiliate system;

FIG. 3 is a block diagram showing an exemplary configuration of a first embodiment of the present invention;

FIG. 4 is a flowchart showing an example of the operation in various registration processes in the first embodiment of the present invention;

FIG. 5 is a flowchart showing an example of the operation in a cooperation process in the first embodiment of the present invention;

FIG. 6 is a flowchart showing an example of the operation of a settlement process in the first embodiment of the present invention;

FIG. 7 is a block diagram showing an exemplary configuration of a second embodiment of the present invention;

FIG. 8 is a block diagram showing an exemplary configuration of a service server in the second embodiment of the present invention;

FIG. 9 is a flowchart showing an example of the cooperation process in the second embodiment of the present invention;

FIG. 10 is a flowchart showing an example of a settlement process in the second embodiment of the present invention;

FIG. 11 is a block diagram showing an exemplary configuration of a cooperation server in a third embodiment of the present invention;

FIG. 12 is a block diagram showing an exemplary configuration of a first example of the present invention;

FIG. 13 is a diagram showing an example of business entity data in the first example of the present invention;

FIG. 14 is a diagram schematically showing an example of the operation of a cooperation module in the first example of the present invention;

FIG. 15 is a diagram showing an example of developer data in the first example of the present invention;

FIG. 16 is a diagram showing an example of a display image displayed on a computer in the first example of the present invention;

FIG. 17 is a diagram showing an example of a formula used for calculating an incentive amount in the first embodiment of the present invention;

FIG. 18 is a diagram showing an example of the relation between the web sites and the cooperation modules in the first example of the present invention;

FIG. 19 is a diagram showing an example of a formula used for calculating an incentive amount in a second example of the present invention;

FIG. 20 is a diagram showing an example of business entity data in a third embodiment of the present invention;

FIG. 21 is a diagram showing the relation between the web sites and incentives in a fifth example of the present invention;

FIG. 22 is a diagram showing an example of a formula used for calculating an incentive amount in a fifth example of the present invention; and

FIG. 23 is a diagram showing an example of a formula used for calculating an incentive amount in a sixth example of the present invention.

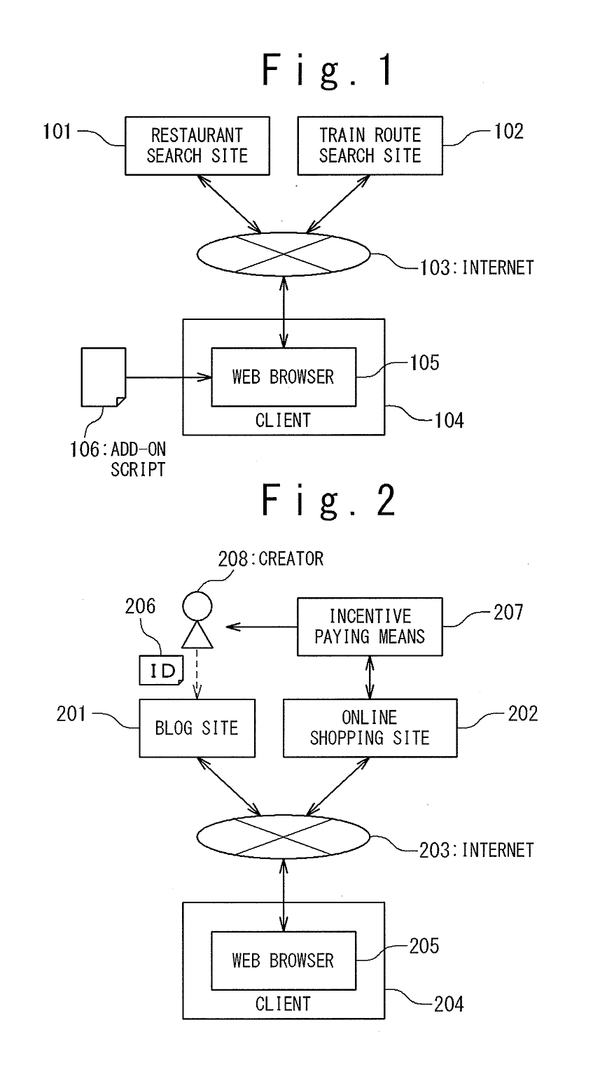

### EMBODIMENTS OF INVENTION

### First Embodiment

A description is given of a first embodiment of the present invention with reference to the attached drawings.

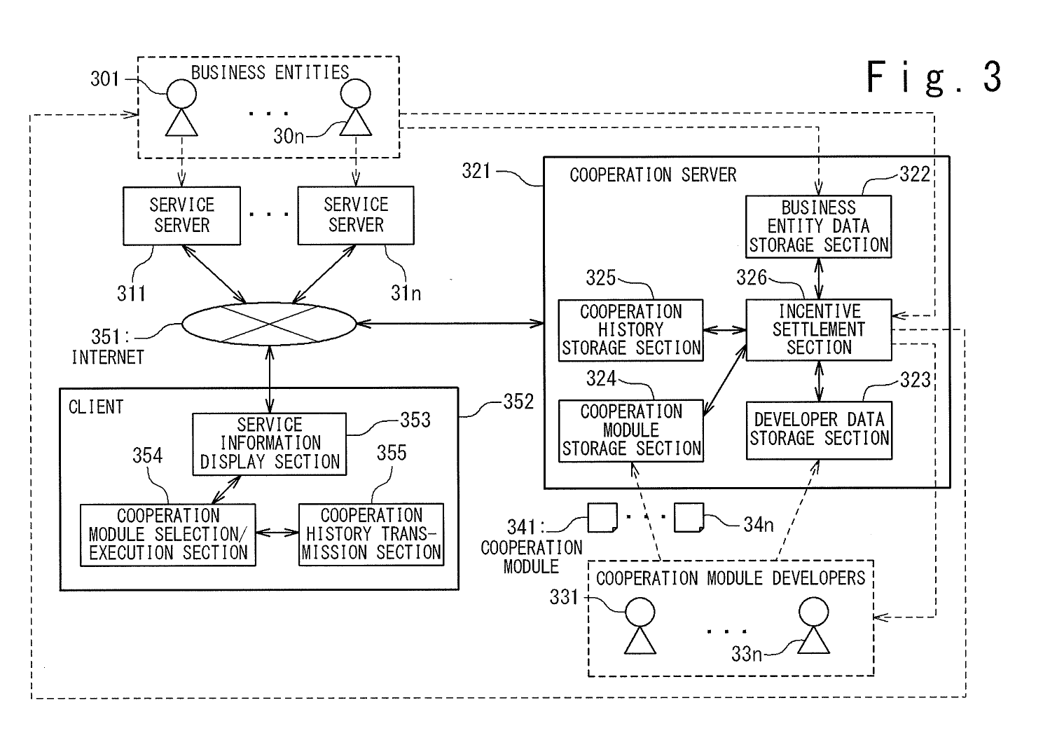

As shown in FIG. 3, an incentive-based server cooperation system according to the present invention includes service servers 311 to 31n (n being an arbitrary number), a cooperation server 321 and client 352.

The service servers 311 to 31n provide services via a network 351. It should be noted that each of the service servers 311 to 31n includes service applications (not shown) for providing services as their components.

The cooperation server 321 provides cooperation between the service servers 311 to 31n via the network 351. The cooperation server 321 includes a business entity data storage section 322, a developer data storage section 323, a cooperation module storage section 324, a cooperation history storage section 325 and an incentive settlement section 326.

The client 352 is a client terminal to be operated by a user. The client 352 includes a service information display section 353, a cooperation module selection/execution section 354 and a cooperation history transmission section 355.

These components each operate schematically as follows:

The business entities 301 to 30n run the service servers 311 to 31n. Here, each of the business entities 301 to 30n is assumed to have a communication terminal or communication device for communicating with the service servers 311 to 31n and the cooperation server 321. In other words, the “business entity” can be interpreted as a “business entity terminal”. It should be noted that, when a business entity directly operates a service server, the service server or an input device thereof operates as the business entity terminal. Various data necessary for settlement are registered in the business entity data storage section 322 in response to operations by the business entities 301 to 30n or an operator (not shown) of the cooperation server 321. The various data include, for example, names of the business entities, incentive amounts, and account numbers of financial institutions used for settlement.

The cooperation module developers 331 to 33n develop cooperation modules 341 to 34n and provide the cooperation modules 341 to 34n to the cooperation server 321.

Here, each of the cooperation module developers 331 to 33n is assumed to have a communication terminal or communication device for communicating with the cooperation server 321. In other words, the “cooperation module developer” can be interpreted as a “cooperation module developer terminal”. It should be noted that, when a cooperation module developer directly operates the cooperation server, the cooperation server or an input device thereof operates as the cooperation module developer terminal. Various data necessary for settlement are registered in the developer data storage section 323 in response to operations by the cooperation module developers 331 to 33n. The various data include, for example, names of the developers and account numbers of financial institutes used for settlement. In addition, the cooperation module storage section 324 stores the cooperation modules 341 to 34n developed by the cooperation module developers 331 to 33n, in response to operations by the cooperation module developers 331 to 33n or the operator (not shown) of the cooperation server 321.

The user uses the service server 311 to 31n via the network 351 by operating the service information display section 353 of the client 352. Here, the cooperation module selection/execution section 354 may select and execute the cooperation modules 341 to 34n stored in the cooperation module storage section 324 in response to operations by the user, to achieve cooperation between multiple service servers. When the cooperation modules 341 to 34n are selected and executed, the cooperation history transmission section 355 acknowledges that the user uses the cooperation modules 341 to 34n and transmits the use histories of the cooperation modules 341 to 34n to the cooperation server 321 to store the use histories in the cooperation history storage section 325.

The incentive settlement section 326 determines the amounts of incentives to be paid to the cooperation developers 331 to 33n and performs settlement processes via bank accounts and the like, referring to the use histories of the cooperation modules 341 to 34n stored in the cooperation history storage section 325 and the incentive amounts of the respective business entities stored in the business entity data storage section 322.

It should be noted that the service servers 311 to 31n may be web servers outputting web pages (HTML documents) or servers which provide services for external systems by using various protocols. Examples of such services may include a web service using SOAP (simple object access protocol) or a web API based on REST (representational state transfer) architecture.

### Example of Hardware

Examples of the service servers 311 to 31n and the cooperation server 321 may include PCs (personal computers), servers of thin client systems, computers such as, work stations, main frames, and super computers. The service servers 311 to 31n and the cooperation server 321 may be virtual machine (VM) environments established on computers.

Examples of the business entity data storage section 322, the developer data storage section 323, the cooperation module storage section and the cooperation history storage section 325 may include semiconductor memory devices such as RAMs (random access memories), ROMs(read only memories), EEPROMs (electrically erasable and programmable read only memories) and flash memories, auxiliary memory units such as HDDs (hard disk drives) and SSD (solid state drives), and removable disks and memory media such as DVD (digital versatile disk) and SD memory cards (secure digital memory cards). The business entity data storage section 322, the developer data storage section 323, the cooperation module storage section and the cooperation history storage section 325 are not limited to memory devices incorporated in a computer; these sections may be implemented as a peripheral device (an external HDD and the like), a storage device provided in an external server (a file server and the like), a DAS (direct attached storage), an FC-SAN(fibre channel—storage area network), an NAS(network attached storage), or an IP-SAN(IP-storage area network).

Examples of the incentive settlement section 326 may include a processor such as a CPU (central processing unit) and a micro processor, and a semiconductor integrated circuit (IC) having the similar function. It should be noted that the incentive settlement section 326 may be a program which causes a computer to execute the incentive settlement process.

Also, the network 351 maybe the Internet, a LAN (local area network), a wireless LAN, a cable television (CATV) line, a fixed telephone network, a cell phone network, a lease line, a serial communication line or a data bus.

Although only one client 352 is shown in FIG. 3 for convenience, many clients 352 may be actually engaged.

The client 352 maybe a PC (personal computer), a thin client terminal, a work station, a PDA (personal digital assistant), a cell phone, a television with the datacasting reception function, a car navigation system, a portable video game machine, a home video game machine, a digital tuner, a digital recorder, an information home appliance, an OA (office automation) appliance. The client 352 may be mounted on a movable body such as a vehicle, a ship, and an airplane.

The service information display section 353 may be a web browser which shows web pages or software having the function of acquiring data described in accordance with a specific specification from a server and displaying the data on the screen. Such software may be implemented as, for example, an email application, an online map application which acquires map data from a server or an Internet radio application.

The service information display section 353 and the service applications on the service servers 311 to 31n may constitute a client-server system in which data in a specific format are exchanged. Also, a service server function (service application) may be implemented on the client 352.

Examples of the cooperation module selection/execution section 354 and the cooperation history transmission section 355 may include a processor such as a CPU and a microprocessor, and a semiconductor integrated circuit (IC) having the similar function. It should be noted that the cooperation module selection/execution section 354 and the cooperation history transmission section 355 may be a program which causes a computer to execute the respective functions thereof.

In this embodiment, the cooperation module selection/execution section 354 includes an input device for accepting an operation by the user. Examples of the input device may include a keyboard, a keypad, an on-screen keypad, a touch panel, a tablet, and reading devices of an IC chip and a storage medium. Alternatively, the input device may be an interface (I/F) which acquires data from an external input device or storage device.

It should be noted that, the actual implementation is not limited to these examples.

### Operation in the Present Embodiment

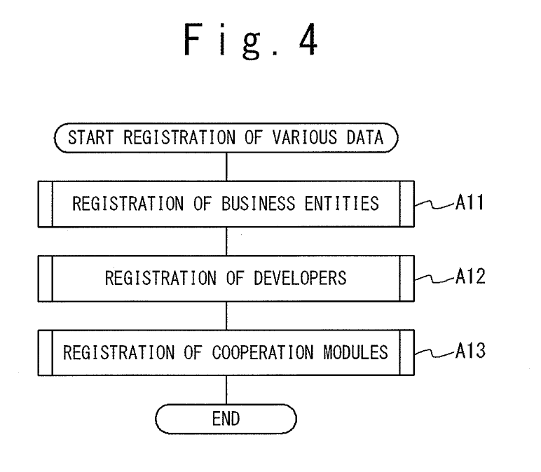

Next, a description is given of the overall operation in the present embodiment, with reference to the flowcharts shown in FIGS. 4 to 6.

### [Registration Process of Various Data]

First, a description is given of a registration process of various data with reference to FIG. 4.

### (1) Step A11

Various data necessary for settlement are registered in the business entity data storage section 322 in response to operations by the business entities 301 to 30n who run the service servers 311 to 31n and the operator (not shown) of the cooperation server 321.

### (2) Step A12

Also, various data necessary for settlement are registered in the developer data storage section 323 in response to operations by the cooperation module developers 331 to 33n and the operator (not shown) of the cooperation server 321.

### (3) Step A13

The developed cooperation modules 341 to 34n are registered in the cooperation module storage section 323 in response to operations by the cooperation module developers 331 to 33n. It should be noted that steps All to A13 are not necessarily implemented in this order; the respective business entities and developers may perform the registration operations appropriately. The order of the registrations of the various data may be random.

### [Cooperation Process]

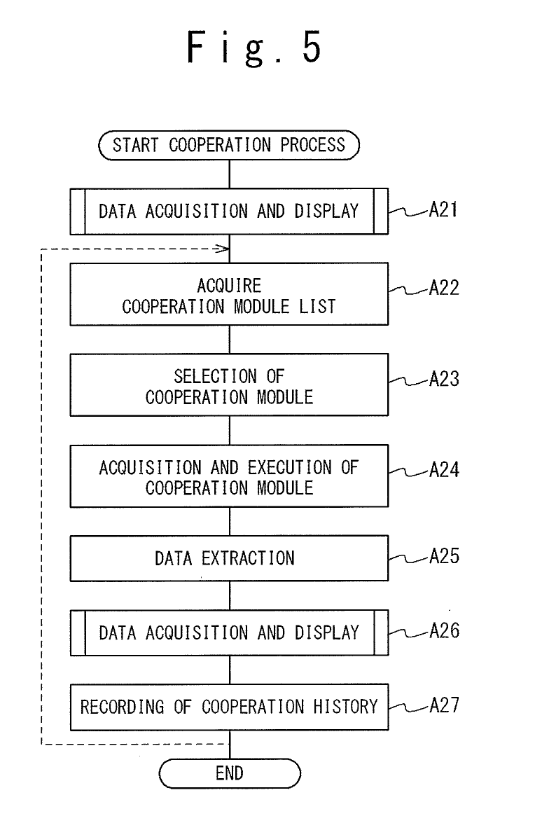

Next, a description is given of the cooperation process, with reference to FIG. 5.

### (1) Step A21

The service information display section 353 acquires information from any one of the service servers 311 to 31n and displays the information on the screen.

### (2) Step A22

When the user desires to achieve cooperation with another service server, the cooperation module selection/execution section 354 displays a list of the cooperation modules 341 to 34n registered in the cooperation server 321 in response to an operation by the user.

### (3) Step A23

Furthermore, the cooperation module selection/execution section 354 selects one cooperation module from among the cooperation modules 341 to 34n displayed in a list, in response to an operation by the user.

### (4) Step A24

The cooperation module selection/execution section 354 acquires the selected cooperation module 341 to 34n from the cooperation module storage section 324 via the network 351 and executes the acquired cooperation module 341 to 34n.

### (5) Step A25

The selected cooperation module 341 to 34n extracts necessary information from the information already acquired from the service server 411 to 41n which is the cooperation source upon starting the execution of the selected cooperation module 341 to 34n.

### (6) Step A26

The selected cooperation module 341 to 34n controls the service information display section 353 as determined in advance for each cooperation module. The service information display section 353 acquires information by transmitting necessary information to the cooperation destination service server under control of the selected cooperation module 341 to 34n and displays the acquired information on the screen.

### (7) Step A27

Finally, the cooperation history transmission section 355 transmits data necessary for calculation of the amount of the incentive, such as, data indicating which of the cooperation modules 341 to 34n is used (data indicating the used cooperation module) to the cooperation history storage section 325 and records the data in the cooperation history storage section 325.

It should be noted that the cooperation module acquired in step A24 maybe stored in the cache in the client 352 in case of execution of the same cooperation module in future.

The data extraction at step A25 may be achieved by specifying any field of a formed document (data), such as XML, or by text pattern matching of non-formed document (data) such as HTML. It should be noted that the actual implementation is not limited to these processes.

Furthermore, cooperation with other service servers may be achieved by repeating the procedure of steps A22 to A27, on the basis of the information acquired from the cooperation destination service server at step A26.

Also, the data to be transmitted to the cooperation history storage section 323 at step A27 may be accumulated in the client 352 to some extent and then collectively transmitted, instead of being immediately transmitted by the cooperation history transmission section 355.

### [Settlement Process]

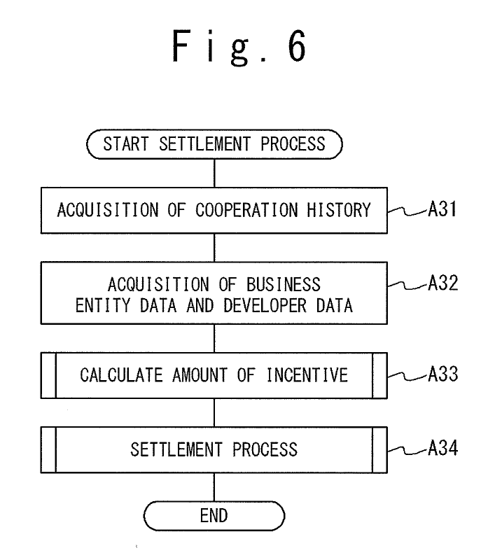

Next, a description is given of the settlement process with reference to FIG. 6.

### (1) Step A31

The cooperation server 321 starts a settlement process at a desired timing, for example, every day, once a month and the like. At this time, the incentive settlement section 326 acquires the past cooperation histories from the cooperation history storage section 325.

### (2) Step A32

Furthermore, the incentive settlement section 326 acquires data necessary for the settlement from the business entity data storage section 322 and the developer data storage section 323.

### (3) Step A33

The incentive settlement section 326 then calculates incentive amounts in accordance with a predetermined method.

### (4) Step A34

The incentive settlement section 326 achieves payment of the incentives from the business entities 301 to 30n to the cooperation module developers 331 to 33n, through processes, such as withdrawal or cash transfer from accounts of financial institutes.

It should be noted that steps A31 and A32 may be implemented in the reverse order. The cooperation modules 341 to 34n may be created by the business entities 301 to 30n who run the respective service servers or the operator (not shown) of the cooperation server 321, and they receive the incentives.

Furthermore, although the payment destinations of the incentives are the cooperation module developers in the present invention, the payment destinations may include a business entity who runs a service server. The system may be modified so that incentives are exchanged among business entities; for example, an incentive is paid from the cooperation destination service server to the cooperation source service server.

The incentives may be paid to the developers of the cooperation modules from the business entity who runs the cooperation source service server instead of from the business entity who runs the cooperation destination service server, or from the both.

In addition, a settlement process may be implemented every when a cooperation module is used by a user, or the operator of the cooperation server collects charges for service.

The present embodiment requires the business entities to only perform business entity registration into the cooperation server, instead of to provide the incentive payment function for their own service servers, in order to allow the cooperation server to perform the payment processes of the incentives, and this results in that many business entities who run service servers can pay incentives to the developers of cooperation modules.

If many business entities who run service servers come to pay incentives to the developers of cooperation modules, this motivates developers to create cooperation modules, resulting in creation and provision of many cooperation modules; this makes it possible for users to use cooperation modules of various service servers, improving the convenience.

Also, the improvement of the user convenience results in that many users uses this system, causing various effects to the business entities of the service servers, such as an increase in the number of users and an increase in the sales of products.

Furthermore, the system can be configured so that business entities as well as the developers of the cooperation modules acquire incentives; this encourages many business entities of the service servers to perform business entity registration into the cooperation server, and accordingly allows the business entities to pay incentives to the developers of the cooperation modules.

### Second Embodiment

Next, a description is given of a second embodiment of the present invention, with reference to the attached drawings. The present embodiments is different from the first embodiment of the present invention in that the incentives are changeable depending on the manner and effect of the cooperation; the incentives are not fixed.

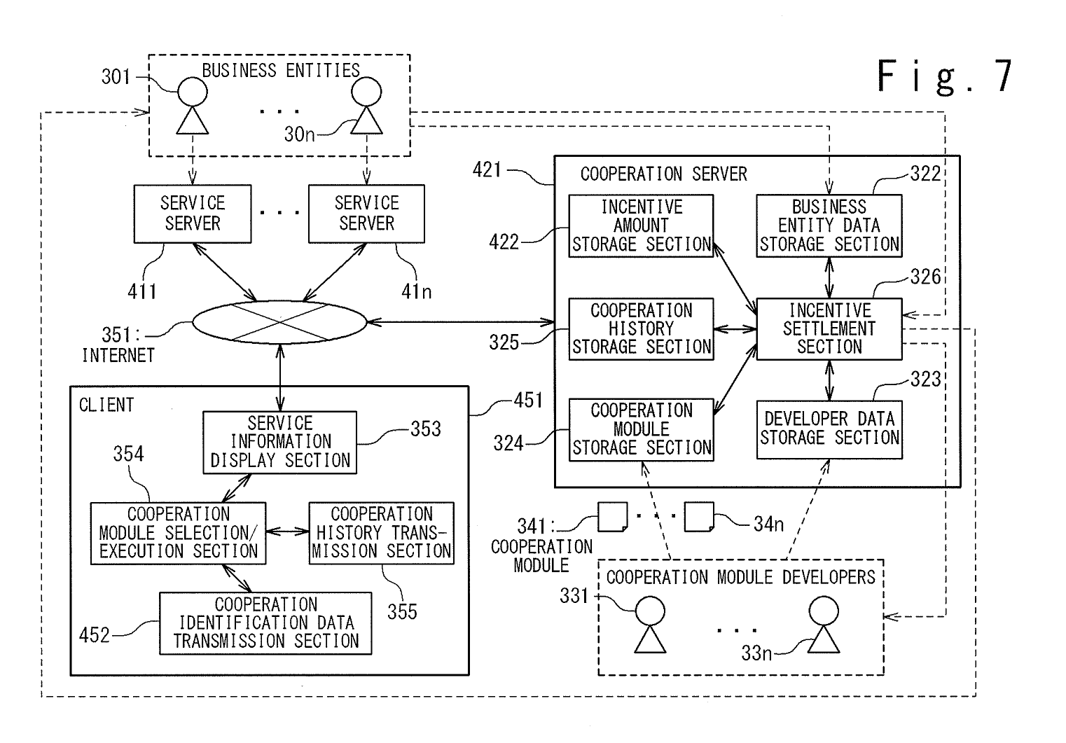

As shown in FIG. 7, the incentive-based server cooperation system of the second embodiment of the present invention includes service servers 411 to 41n, a cooperation server 421 and a client 451.

The service servers 411 to 41n provide services via a network 351. It should be noted that each of the service servers 411 to 41n includes a service application (not shown) for providing services as a component thereof.

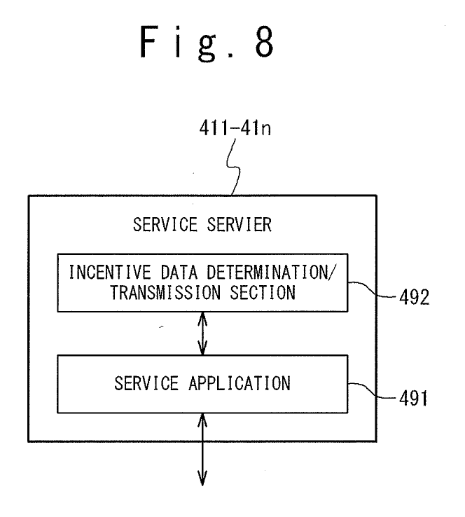

As shown in FIG. 8, the service servers 411 to 41n each include a service application 491 and an incentive data determination/notification section 492.

The cooperation server 421 achieves cooperation of the service servers 411 to 41n via the network 351. The cooperation server 421 includes a business entity data storage section 322, a developer data storage section 323, a cooperation module storage section 324, a cooperation history storage section 325, an incentive settlement section 326 and an incentive amount storage section 422.

The client 451 is a client terminal to be operated by a user. The client 451 includes a service information display section 353, a cooperation module selection/execution section 354, a cooperation history transmission section 355 and a cooperation identification data transmission section 452.

Compared to the configuration of the first embodiment of the present invention shown in FIG. 3, the configuration of the second embodiment of the present invention shown in FIG. 7 is different in that the cooperation server 421 includes the incentive amount storage section 422 and the client 451 includes the cooperation identification data transmission section 452. Furthermore, as shown in FIG. 8, the difference also exists in that the service servers 411 to 41n include the service application 491 and the incentive data determination/notification section 492. It should be noted that the same components shown in FIG. 3 are denoted by the same numerals.

These components each operate schematically as follows:

When users use the service servers 411 to 41n by operating the service information display section 353 so as to achieve cooperation between the service servers 411 to 41n, the cooperation identification data transmission section 452 of the client 451 transmits identification data for identifying which of the cooperation module 341 to 34n are executed to the incentive data determination/notification section 492 of the cooperation destination service servers.

The incentive data determination/notification section 492 determines the amounts of incentives on the basis of the transmitted identification data, and notifies the amounts of the incentives to the incentive amount storage section 422 in cooperation server 421. The identification data of the cooperation modules and data of the service servers of the cooperation sources, and, if the user have bought commercial products in the cooperation, the sales of the products are used in order to the amounts of the incentives. It should be noted that the service servers of the cooperation sources can be identified from the identification data of the cooperation modules which have been used in the cooperation.

The incentive settlement section 326 determines the amounts of the incentives to be paid to the cooperation module developers 331 to 33n by referring to the amounts of the incentives stored in the incentive amount storage section 422 and the use histories of the cooperation modules 341 to 34n stored in the cooperation history storage section 325, and performs settlement processes via bank accounts and the like.

Next, a description is given of the overall operation of the present embodiment, with reference to flowcharts shown in FIGS. 4, 9 and 10.

First, with respect to the registration process of various data shown in FIG. 4, the same process as that in the first embodiment of the present invention is performed and no detailed description thereof is given.

### [Cooperation Process]

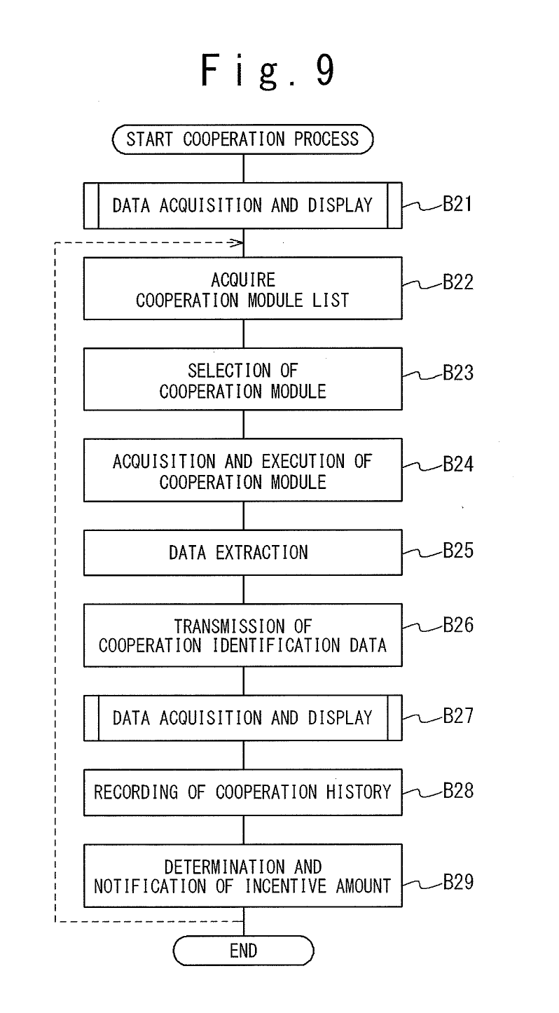

Next, a description is given of a cooperation process with reference to FIG. 9.

### (1) Step B21

The service information display section 353 acquires information from any one of the service servers 411 to 41n in response to an operation by the user, and displays the information on the screen.

### (2) Step B22

When the user desires to achieve cooperation with another service server, the cooperation module selection/execution section 354 displays a list of the cooperation modules 341 to 34n registered in the cooperation server 421 in response to an operation by the user.

### (3) Step B23

The cooperation module selection/execution section 354 selects one cooperation module from the list of the cooperation modules 341 to 34n in response to an operation by the user.

### (4) Step B24

The cooperation module selection/execution section 354 acquires the selected cooperation module from the cooperation module storage section 423 via the network 351 and executes the acquired cooperation module 341 to 34n.

### (5) Step B25

When executed, the cooperation module 341 to 34n extracts necessary data from the information already acquired from the cooperation source service server 411 to 41n.

### (6) Step B26

The cooperation module 341 to 34n controls the service information display section 353 as predetermined for each cooperation module 341 to 34n. The service information display section 353 transmits data necessary for acquiring information from the cooperation destination service server 411 to 41n under the control of the cooperation module 341 to 34n. In this case, the cooperation identification data transmission section 452 also transmits data for identifying the currently-executed cooperation module 341 to 34n (cooperation identification data) to the cooperation destination service server 411 to 41n.

### (7) Step B27

The service information display section 353 then acquires information from the cooperation destination service server 411 to 41n and display the acquired information on the screen.

### (8) Step B28

The cooperation history transmission section 355 then transmits data necessary for calculating the incentive amount, such as data indicating which cooperation module is used among the cooperation modules 341 to 34n (data indicating the used cooperation module) to the cooperation history storage section 325 and records them into the cooperation history storage section 325.

### (9) Step B29

Also, the cooperation destination service server 411 to 41n determines the amount of the incentive on the basis of the identification data of the cooperation module received from the cooperation identification data transmission section 452, data of the cooperation source service server 411 to 41n and data of the profit obtained from the user by the cooperation destination service server 411 to 41n, such as the sales, and notifies the determined amount of the incentive to the incentive amount storage section 422 of the cooperation server 421.

It should be noted that the cooperation destination server 411 to 41n may achieve cooperation with another service server based on data acquired at Step B27 from the cooperation destination service server by repeating the procedure of Steps B22 to B29.

It should be also noted that the determination and notification of the incentive amount by the service server at step B29 may be collectively performed after accumulating necessary data, instead of being performed each when a cooperation module is used.

### [Settlement Process]

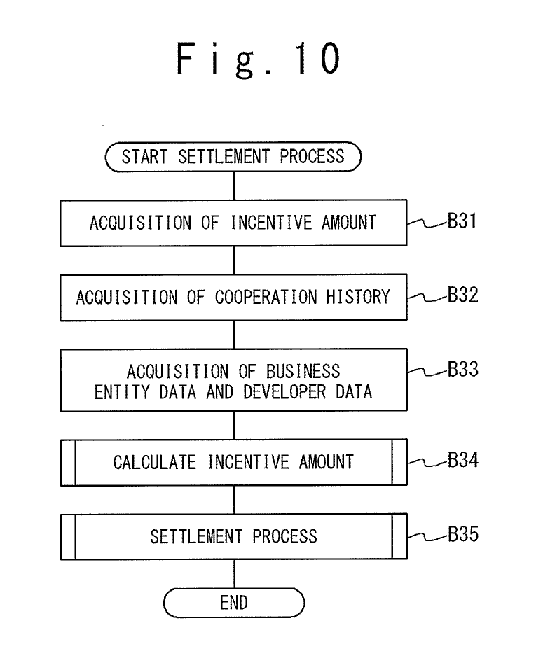

Next, a description is given of a settlement process with reference to FIG. 10.

### (1) Step B31

The cooperation server 421 starts the settlement process at desired timings, for example, every day, once a month and the like. The incentive settlement section 326 then acquires the incentive amounts stored in the incentive amount storage section 422. It should be noted that the incentive amounts are notified from the service serves 411 to 41n from step B29.

### (2) Step B32

The incentive settlement section 326 acquires the cooperation histories of the past from the cooperation history storage section 325.

### (3) Step B33

Furthermore, the incentive settlement section 326 acquires data necessary for settlement from the business entity data storage section 322 and the developer data storage section 323.

### (4) Step B34

The incentive settlement section 326 then calculates the amounts of the incentives in accordance with a predetermined scheme.

### (5) Step B35

The incentive settlement section 326 achieves payment of the incentives from the business entities 301 to 30n to the cooperation module developers 331 to 33n, through processes, such as withdrawal or cash transfer from accounts of financial institutes.

It should be noted that the order of steps B31 to B33 may be changed. It should be also noted that the cooperation modules 341 to 34n may be created by the business entities 301 to 30n who respectively run the service servers and the operator of the cooperation server 421, and the incentives may be paid to them.

The service servers 311 to 31n of the first embodiment of the present invention, for which the incentives are fixed, maybe additionally provided. When the cooperation destination is such a service server, steps B26 and B29 are omitted, and the calculation of the incentive amounts at step B34 is performed in the same way as the first embodiment of the present invention for such a service server; the data stored in the incentive amount storage section 422 are not used.

Furthermore, although the destinations of the payment of the incentives are determined as the cooperation module developers in the present embodiment, the destinations of the payment may include a business entity who runs a service server; the incentives may be paid mutually among the business entities, for example, from the cooperation destination service servers to the cooperation source service servers.

Also, the incentives to be paid to the developers of the cooperation modules may be paid from business entities who run the cooperation source service servers in place of business entities who run the cooperation destination service servers, or from the both.

It should be noted that, when the incentives are paid by the cooperation source service servers, the transmission destinations of the data for identifying the cooperation modules are transmitted to the cooperation source service servers at step B26 and the cooperation source service servers perform the determination/notification process of the incentive amounts at step B29.

In addition, a settlement process maybe implemented, every when a cooperation module is used by a user, or the operator of the cooperation server collects charges for service.

The present embodiment is configured so that the amounts of the incentives from the business entities who run the service servers to the developers of the cooperation modules are changeable depending on the way and effect of the cooperation, and this makes it possible to perform an operation in which, when a user bus a commercial product on a cooperation destination service server, for example, the amount of the incentive is determined as a predetermined ratio of the price.

### Third Embodiment

Next, a detailed description is given of a third embodiment of the present invention with reference to the attached drawings. An incentive-based server cooperation system of the third embodiment of the present invention includes service servers 311 to 31n, a cooperation server 321 and a client 352, as is the case with the first embodiment shown in FIG. 3. The present embodiment is different from the first embodiment shown in FIG. 3 only in the configuration of the cooperation server 321. The cooperation server 321 of the present embodiment is referred to as cooperation server 501, hereinafter. In the present embodiment, the developers of the cooperation modules can configure the amounts of incentives as they desire.

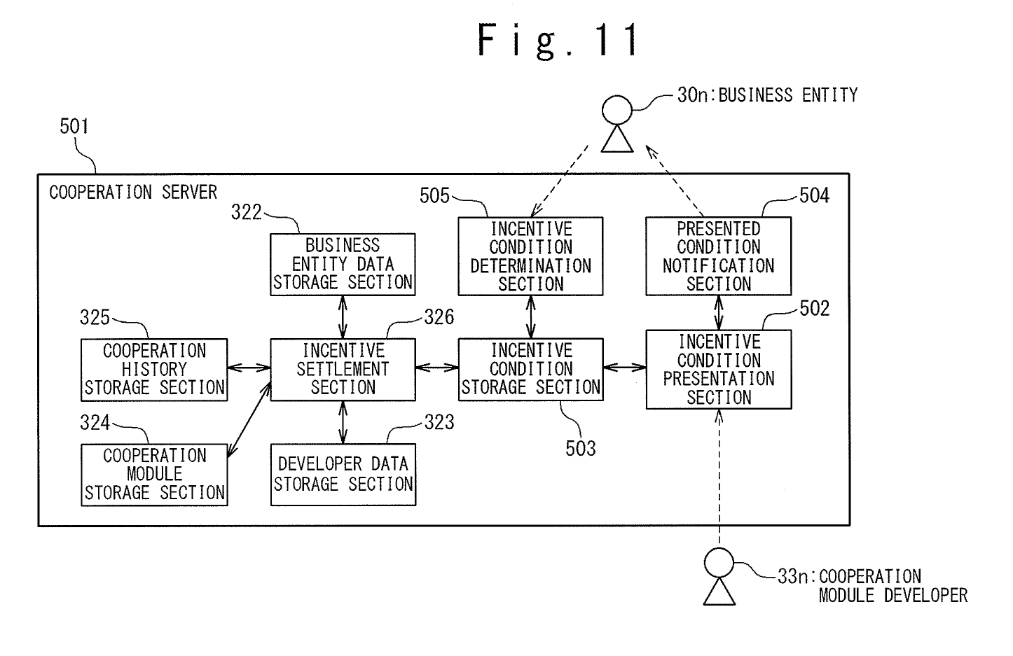

As shown in FIG. 11, the cooperation server 501 includes a business entity data storage section 322, a developer data storage section 323, a cooperation module storage section 324, a cooperation history storage section 325, an incentive settlement section 326, an incentive condition presentation section 502, an incentive condition storage section 503, a presented condition notification section 504 and an incentive condition determination section 505.

Compared to the cooperation server 321 of the first embodiment shown in FIG. 3, the cooperation server 501 of the third embodiment of the present invention is different in that the cooperation server 501 additionally includes the incentive condition presentation section 502, the incentive condition storage section 503, the presented condition notification section 504 and the incentive condition determination section 505. It should be noted that the same components shown in FIG. 3 are denoted by the same numerals.

These sections each operate schematically as follows:

The cooperation module developer 33n configures a desired incentive condition (for example, the unit price of the incentive) by operating the incentive condition presentation section 502, when registering the developed cooperation module 34n by operating the cooperation module storage section 324. In other words, the cooperation module storage section 324 is registered with the developed cooperation module 34n in response to an operation by the cooperation module developer 34n. At this time, the incentive condition presentation section 502 configures the incentive condition in response to an operation by the cooperation module developer 33n.

The configured incentive condition is stored in the incentive condition storage section 503 and notified to the business entity 30n who runs the service server for which the relevant cooperation module provides cooperation. In other words, the incentive condition storage section 503 stores the configured incentive condition. The presented condition notification section 502 notifies the configured incentive condition to the business entity 30n who runs the service server for which the relevant cooperation module provides the cooperation.

The business entity 30n considers incentive conditions presented by one or more developers (at least one developer) and the functions of the created cooperation modules and determines whether to accept or to refuse respective presented incentive conditions by operating the incentive condition determination section 505. At this time, the incentive condition determination section 505 determines whether to accept or to refuse each of the incentive conditions presented by one or more developers, in response to an operation by the business entity 30n.

The incentive settlement section 326 determines the amounts of the incentives on the basis of the incentive conditions stored in the incentive condition storage section 503, when settling the incentives.

Although FIG. 11 shown only one cooperation module developer and one business entity for convenience, there maybe multiple cooperation module developers and business entities in actual implementation.

Also, the incentive condition stored in the incentive condition storage section 503 may be modified under an agreement with the cooperation module developer 33n, when the business entity 30n determines whether to accept the incentive condition by operating the incentive condition determination section 505. In other words, the incentive condition determination section 505 may modify the incentive condition stored in the incentive condition storage section 503 in response to an operation by the business entity 30n based on an agreement with the cooperation module developer 33n, when determining whether to accept the incentive condition. Alternatively, the incentive condition determination section 505 may accept an operation by the cooperation module developer 33n and modify the incentive condition stored in the incentive condition storage section 503 in response to respective operations by the business entity 30n and the cooperation module developer 33n.

In notifying the business entity 30n, if his/her contact address is stored in the business entity data storage section 322, the presented condition notification section 504 may use the contact address; if his/her contact address is no stored in the business entity data storage section 322, the presented condition notification section 504 may prompt to input the contact address of the business entity 30n when the developer 33n inputs the condition into the incentive condition presentation section 502.

In the present embodiment, the cooperation module developer can present the desired incentive condition, since the present embodiment is configured so that the incentive condition can be determined by the cooperation module developer and the business entity who runs the service server. Also, business entities do not necessarily pay incentives for any cases; if a business entity does not accept an incentive condition, it is not necessary for them to pay the incentive.

Next, a description is given of operations in best modes for implementing the present invention, on the basis of specific examples.

### FIRST EXAMPLE

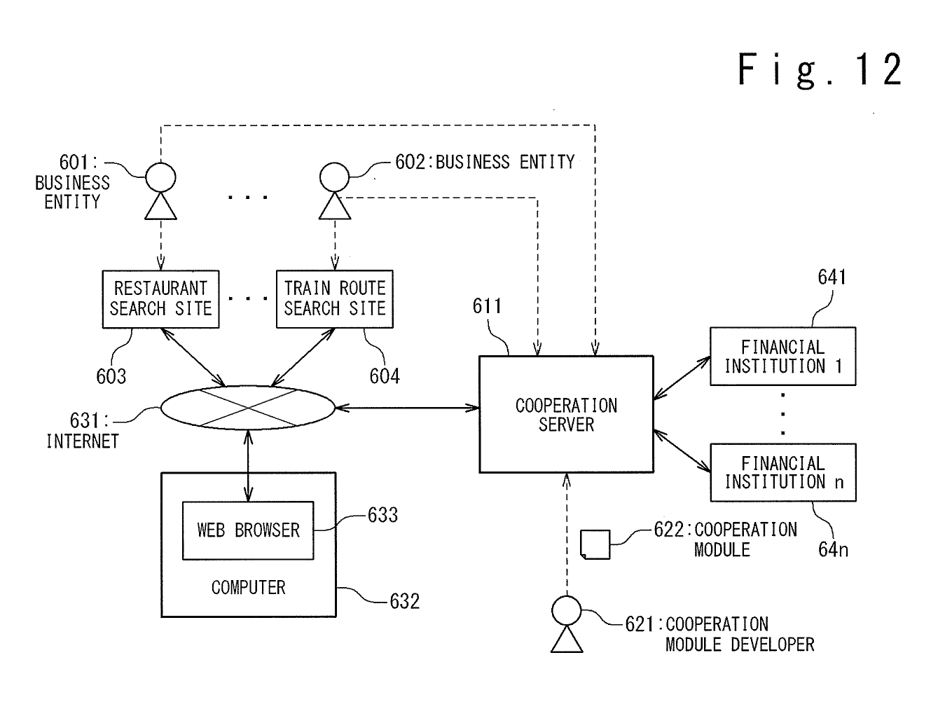

As shown in FIG. 12, an incentive-based server cooperation system in a first example of the present invention includes a restaurant search site 603, a train route search site 604, a cooperation server 611, a computer 632 and financial institutes 641 to 64n.

The restaurant search site 603, the train route search site 604, the cooperation server 611 and a computer 632 are connected via the Internet 631.

The cooperation server 611 provides a web site cooperation function. The computer 632 is a computer operated by a user. That is, the computer 632 is a client terminal. The financial institutes 641 to 64n are financial institutes used for payment of incentives. The financial institutes 641 to 64n are assumed to have communication terminals or communication devices.

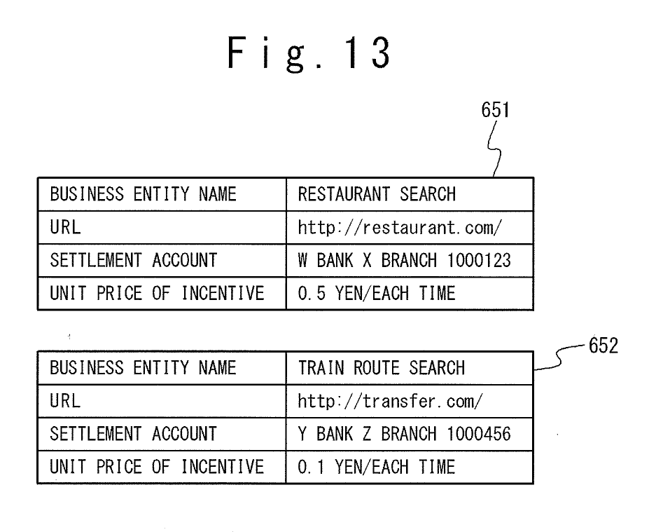

Business entities 601 and 602, who respectively run the restaurant search site 603 and the train route search site 604, have registered business entity data 651 and 652 as shown in FIG. 13, respectively, into the cooperation server 611 in advance.

In this example, a cooperation module developer 621 first creates a cooperation module 622 which extracts the nearest station from the contents of a shop detail page of the restaurant search site 603 and makes a search for the route from one's home to the shop on the train route search site 604, as an extension function of the web browser 633.

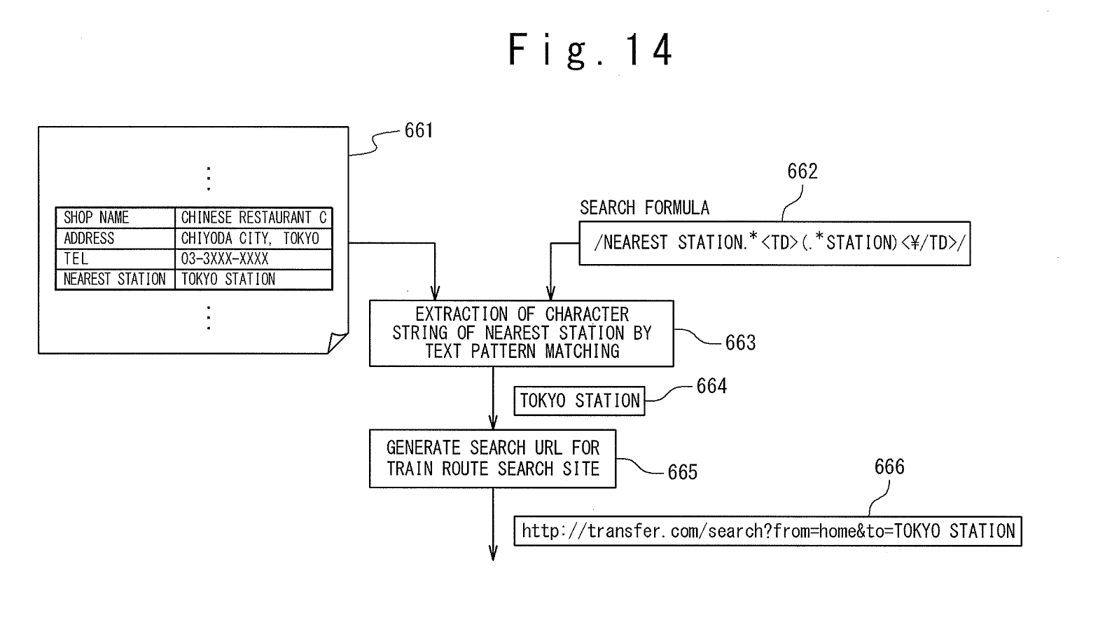

In this example, the cooperation module 622 includes a means for performing an extraction process of the name of the nearest station (which is a specific character string) from the shop detail page (web page) and a means for performing a generation process of a search URL for the train route search site. Examples of the extraction process of the specific character string from the web page may include text pattern matching or a method of operating a DOM (document object model). FIG. 14 shows outlines of a process 663 in which a location 622 at which the nearest station is described is specified and the character string 663 of the station name is extracted from the web page 611, and a process 665 in which a search URL 666 is generated from the extracted station name.

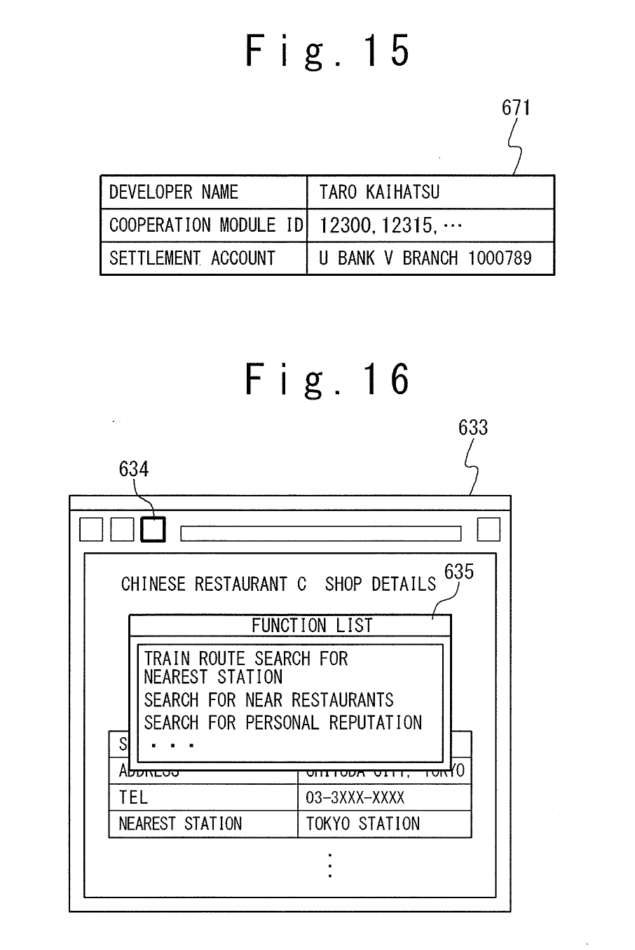

The cooperation module developer 621 registers the created cooperation module into the cooperation server, as well as developer data 671 as shown in FIG. 15. The cooperation server 611 automatically attaches and records a cooperation module ID, each when the created cooperation module is registered.

Then, a user uses the restaurant search site 603. An extension function for selecting, acquiring and executing a cooperation module from the cooperation server 611 has been incorporated into the web browser 633 of the user, in advance. As shown in FIG. 16, when the user pushes a cooperation function start button 634 provided in the web browser 633 after the shop detail page is displayed, a list 635 of cooperation modules available for this page is displayed on the web browser 633. In other words, the web browser 633 displays the list of the cooperation modules available for this page in response to the cooperation function start button 634 being pushed by the user.

When the user selects the aforementioned cooperation module for making a search for the train route to the nearest station, the extension function incorporated into the web browser 633 acquires the cooperation module 622 from the cooperation server 611 and executes the cooperation module 622.

After the cooperation module 622 is executed, the search result of the train route to the nearest station is shown on the screen of the web browser 633 and the fact that the present cooperation module is executed is notified to the cooperation server 611 and recorded as the cooperation history. In other words, the web browser 633 displays the search result of the train route to the nearest station on the screen after the cooperation module 622 is executed. At the same time, the computer 632 notifies the fact that the present cooperation module is executed to the cooperation server 611. The cooperation server 611 records the contents of the notification as the cooperation history.

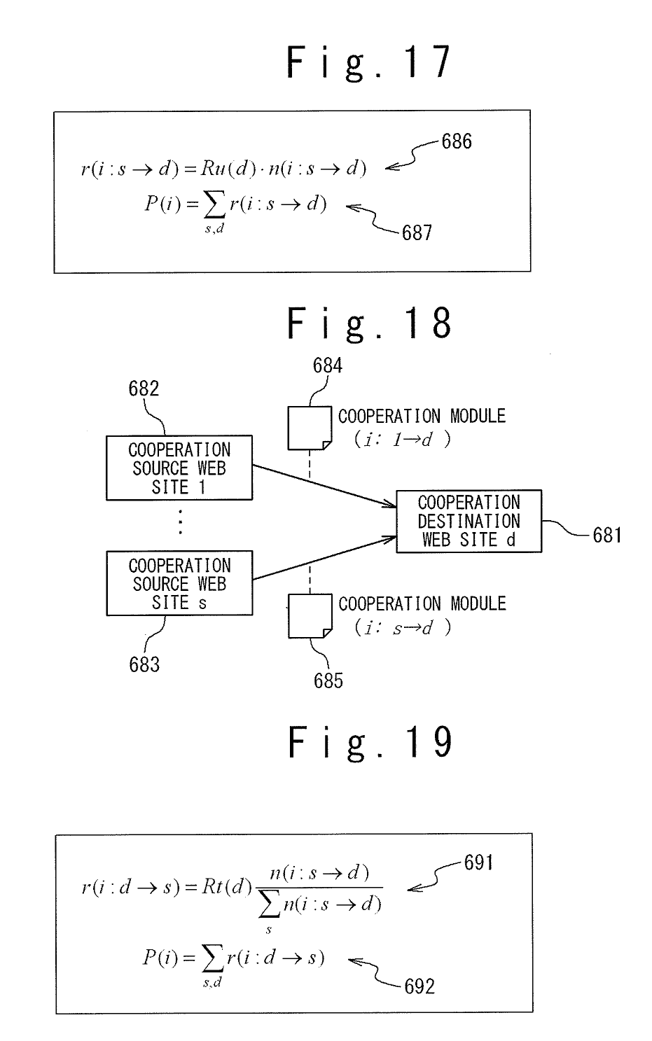

Also, the cooperation server 611 calculates the amounts of the incentives at the end of each month in accordance with the formulas 686 and 687 shown in FIG. 17 and performs a settlement process of the incentives.

FIG. 18 shows an association of cooperation modules 684 to 685 created by a cooperation module developer “i” with a cooperation destination web site 681 (web site “d”) and cooperation source web sites 682 to 683 (web sites “1” to “s”).

In the formulas 686 and 687, r(i: s→d) is the incentive which is received by the cooperation developer “i” from the web site “d” with respect to the cooperation module which provides cooperation from the web site “s” to the web site “d”. Ru(d) is the unit price of the incentive to be paid by the web site “d”. n (i: s→d) is the number of times of uses of the cooperation module from the web site “s” to the web site “d” created by the developer “i”. P (i) is the total sum of the incentives to be received by the developer “i”. It should be noted that it is assumed that n (i: s→d)=0 for cooperation modules which are not developed by the developer “i”.

According to the formulas 686 and 687, the developer 621 of the cooperation module 622 can receive the incentive of the amount obtained by multiplying the unit price of incentive configured in the business entity data 652 by the business entity 602 of the train route search site by the number of times of uses of the cooperation module 622, in the example of FIG. 12. After calculating the amounts of the incentives, the cooperation server 611 asks the financial institutes 641 to 64n for withdrawal processes from accounts of business entities, and deposit processes to accounts of developers.

Although the description is given here on the basis of the example in which one developer creates and registers cooperation modules related to two web sites and one user uses the cooperation modules, one would understand that there are various web sites and that many developers may create and register cooperation modules which achieves cooperation between the web sites in an actual implementation, while many users may use the cooperation modules.

The cooperation server 611 calculates the incentive amounts of the incentives and sums the amounts of the incentives, for each developer with respect to all the cooperation modules created by each developer.

In the above-described example, when a transfer occurs from another web site to the cooperation source restaurant search site 603 by using another cooperation module different from the cooperation module 622, the cooperation server 611 may resign to the developer of the other cooperation module apart of the incentive which has been determined as being to be received by the developer 621 of the cooperation module 622. That is, when cooperation modules are used in series, the cooperation server 611 may distribute incentives to be paid to developers of cooperation modules so that the incentives are handed over in the reverse direction of the series.

Although processes of cooperation modules are typically described in a programming language, such as “JavaScript” (registered trademark), in many cases, the cooperation modules may be instead created by describing character strings used for pattern matching or methods of generating URLs in a configuration file.

Also, different cooperation modules may be created for the character string extraction process and the URL generation process. This allows using the same process in cooperation modules related to the same cooperation source web site (or to the same cooperation destination web site).

Also, the incentives to be paid to the developers of the cooperation modules may be paid from business entities who run the cooperation source service servers in place of business entities who run the cooperation destination service servers, or from the both.

### SECOND EXAMPLE

Next, a description is given of a second example for implementing the present invention. An incentive-based server cooperation system in the second example of the present invention includes various web sites (such as the restaurant search site 603 and the train route search site 604), a cooperation server 611 and a computer 632 operated by a user, as in the first example shown in FIG. 12.

The difference between the first and second examples of the present invention exists in the calculation method of the incentive amounts.

The cooperation server 611 of the second example calculates the amounts of the incentives in the settlement process in accordance with formulas 691 and 692 shown in FIG. 19, where Rt(d) is the total amount of the incentives paid by the web site “d”. The meanings of r, n and P are the same as in FIG. 17 which is related to the first example of the present invention.

The cooperation server 611 divides the total incentive amount Rt(d) configured for the cooperation destination web site “d” among the respective developers so that the allocations are proportional to the number of times of uses of the cooperation modules used for the cooperation to the web site. The cooperation server 611 calculates the allocations of the total incentive amount Rt(d) for each cooperation destination web site and finally calculates the individual incentive amount P(i) to be paid to each developer.

In the second example, the total incentive amount configured by each business entity is distributed to the developers of the respective modules, while the incentive amounts are calculated on the basis of the unit price of incentive in the first example. In this division, a developer of a cooperation module which is used by an increased number of users receives an increased amount of incentive from the business entity of the cooperation destination web site.

An advantage of this scheme is to avoid limitless increases of the incentive amounts to be paid by business entities in accordance with the number of times of uses.

### THIRD EXAMPLE

Next, a description is given of a third example for implementing the present invention. An incentive-based server cooperation system of the third example of the present invention includes various web sites (such as the restaurant search site 603 and the train route search site 604), a cooperation server 611 and a computer 632 operated by a user, as in the first example shown in FIG. 12.

The difference between the first and third examples of the present invention exists in the calculation method of the incentive amounts.

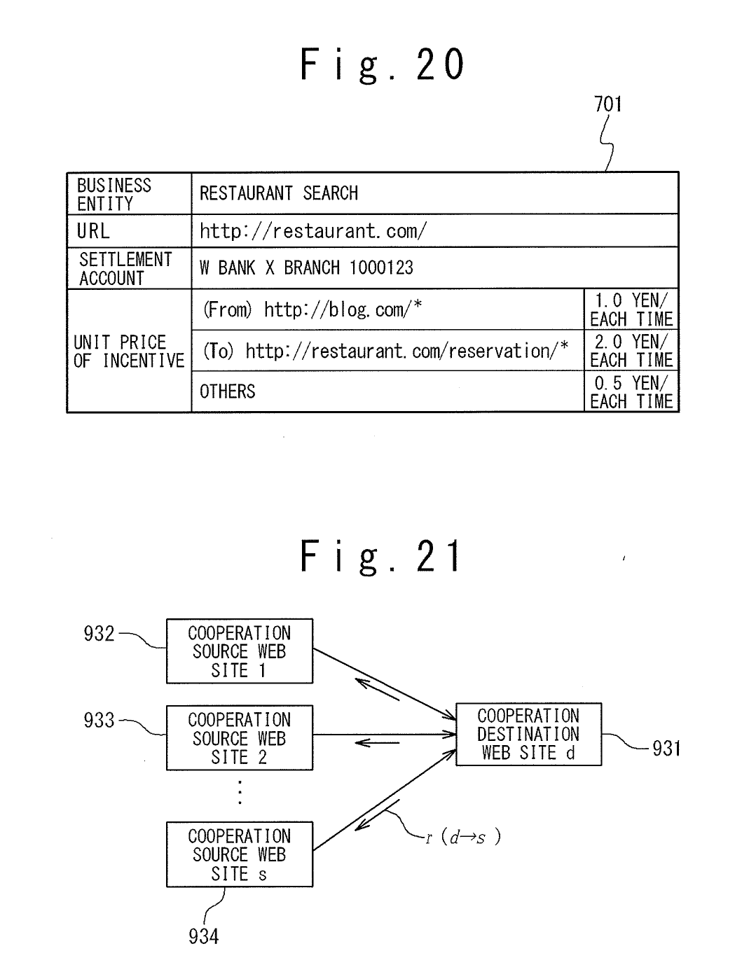

In the third example, operators of web sites (such as the business entities 601 and 602) register business entity data 701 including incentive unit price data shown in FIG. 20 into the cooperation server 611. When a cooperation process is performed on the user computer 632, the used cooperation module and the URLs of the cooperation source web site and the cooperation destination web site are recorded into the cooperation history storage section of the cooperation server 611 (which corresponds to the cooperation history storage section 325).

When performing a settlement process, the cooperation server 611 calculates the amounts of the incentive on the basis of the incentive unit price data shown in FIG. 20. In this example, when the URL of the cooperation source web site matches the URL pattern of the row indicated by “From” or the URL of the cooperation destination site matches the URL of the row indicated by “To”, the incentive amount is calculated in accordance with the unit price set in the relevant row. Although an example of descriptions using the wild card (“*”) is shown here, the URL of a web site may be determined as matching, when the URL includes at least part of the URL of the predetermined row (the row indicated by “From” or “To”), in other words, when the URL of the web site includes a part or the whole of the URL described in the predetermined row or the URL of the web site is completely identical to the URL described in the predetermined row.

It should be noted that the configuration shown in FIG. 20 is only one example; various other methods, including using a programming language, may be used for determining the incentive amounts in accordance with the URLs of the cooperation source web site and the cooperation destination web site.

This scheme provides the business entity who runs the cooperation destination web site with an advantage in which the amounts of the incentives can be modified based on the way or effect of the cooperation; for example, an increased amount of incentive is paid for cooperation to a web page of increased importance and value.

### FOURTH EXAMPLE

Next, a description is given of a fourth example for implementing the present invention. An incentive-based server cooperation system of the fourth example of the present invention includes various web sites (such as the restaurant search site 603 and the train route search site 604), a cooperation server 611 and a computer 632 operated by a user, as in the first example shown in FIG. 12.

The difference between the first and fourth examples of the present invention exists in the calculation method of the incentive amounts.

In the fourth example, the cooperation server 611 provides sorting of the display order in the list 635 of the cooperation modules which is displayed when the cooperation function start button 634 shown in FIG. 16 is pushed by the user to select a cooperation module, in accordance with the unit price of incentive configured by the operators of web sites (the business entities 601 and 602 and so on) in the business entity data 651 and 652 shown in FIG. 13.

Specifically, the cooperation server 611 displays cooperation modules in which web sites run by business entities who configure higher incentive unit price are defined as cooperation destinations at upper locations. This causes the relevant cooperation modules to be easily perceived and used by users.

This scheme allows business entities to increase the number of times of uses of cooperation modules in which their own web sites are defined as destinations by configuring higher incentive amounts; it is expected accordingly that the number of users who are invited to their own web sites is increased. Therefore, this approach causes an effect of encouraging business entities to configure higher incentive amounts.

### FIFTH EXAMPLE

Next, a description is given of a fifth example for implementing the present invention. An incentive-based server cooperation system of the fifth example of the present invention includes various web sites (such as the restaurant search site 603 and the train route search site 604), a cooperation server 611 and a computer 632 operated by a user, as in the first example shown in FIG. 12.

As shown in FIG. 21, the incentive-based server cooperation system of the fifth example of the present invention includes a cooperation destination web site 931 and cooperation source web sites 932 to 934, as the various web sites.

The difference between the first and fifth examples of the present invention exists in that incentives are also paid to business entities who run cooperation source web sites (the business entities 601 and 602 and so on).

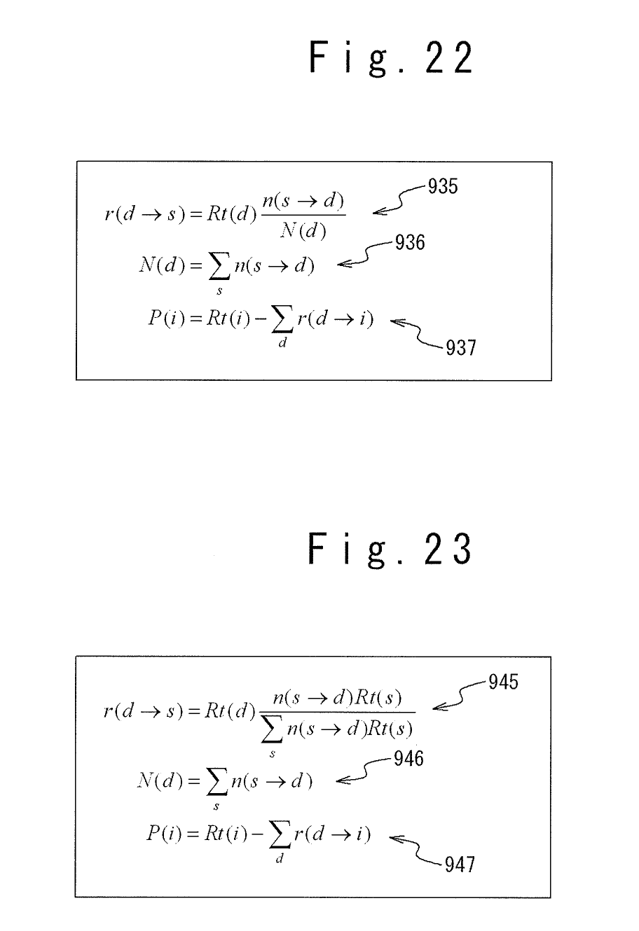

In performing a settlement process, the cooperation server 611 of the fifth example calculates the incentive amounts in accordance with formulas 935 to 937 shown in FIG. 22, where r(d→s) is the incentive which is received by the cooperation source web site “s” from the cooperation destination web site “d”. Rt(d) is the total amount of incentives paid by the web site “d”. n(s→d) is the number of times of cooperation (times of transfer) from the web site “s” to the web site “d”. P(i) is the total amount of incentives paid (or received) by the web site “i” as a result of the settlement.

The cooperation server 611 divides the total incentive amount R configured for the cooperation destination web site 931 in accordance with the formulas 935 to 937 among the operators of the cooperation source web sites (the business entities 601 and 602 and so on) so that the allocations are proportional to the number of times of transfers from the cooperation source web sites 932 to 934. The cooperation server 611 calculates the allocations of the total incentive amounts R for all the cooperation destination web sites, and finally calculates the individual total incentive amounts to be paid (or received) by the operators of the respective web sites (the business entities 601 and 602 and so on). In other words, the total incentive entity P is determined as the balance of payment (income and expenditure) of the operator of each web site.

This approach causes an effect in which an operator who runs a cooperation source web site which invites more users receives a higher incentive from operators who runs cooperation destination web sites.

It should be noted that the cooperation server 611 may configure an incentive amount per cooperation instead of configuring the total incentive amount and dividing it among cooperation source web sites. Also, the cooperation server 611 may change the total incentive amount to be paid (or received) by a cooperation destination web site, according to the profit actually acquired by the cooperation destination web site.

Furthermore, the present example, in which an incentive is paid to a cooperation source web site, may be combined with any of the first to fourth examples of the present invention, so that an incentive is paid to the developer of the cooperation module.

### SIXTH EXAMPLE

Next, a description is given of a six example for implementing the present invention. An incentive-based server cooperation system of the sixth example of the present invention includes various web sites (such as the restaurant search site 603 and the train route search site 604), a cooperation server 611 and a computer 632 operated by a user, as in the fifth example shown in FIG. 12.

The difference between the fifth and sixth examples of the present invention exists in the calculation method of incentives paid to business entities who run cooperation source web sites (the business entities 601 and 602 and so on).

In performing a settlement process, the cooperation server 611 of the sixth example calculates the incentive amounts in accordance with formulas 945 to 947 shown in FIG. 23. The cooperation server 611 distributes the total incentive amount Rt(d) configured for each cooperation destination web site in accordance with the formulas 945 to 947, in response to the ratio of the numbers of times of transfers from the cooperation source web sites and the total incentive amounts Rt(s) configured for the cooperation source web sites.

In other words, a business entity who has configured an increased total incentive amount can receive more incentive than other web sites, when incentives of operators of cooperation destination web sites (business entities 601 and 602 and so on) are distributed.

Adversely, a business entity who has configured a reduced total incentive amount can receive only a reduced amount of incentive compared to other web sites in dividing the incentive.

This scheme causes an effect in which each business entity is encouraged to configure a higher incentive amount as long as their benefit acquired by using this system is reasonable.

Although the present invention is described above in accordance with the embodiments and examples, the present invention is not limited to the configurations of the above-described examples; it would be apparent that the present invention encompasses various changes and modifications, such as appropriate combinations, which would be achieved by the person skilled in the art within the scope of the present invention.

The present invention can be used for the purpose of distributing a profit obtained by a web site to concerned parties as incentives in a system which achieves cooperation on web browsers among multiple web sites over the Internet. Also, the present invention can be used for the purpose of distributing a profit obtained by a business entity who provides a service to other business entities as service,charges in a system which achieves cooperation between multiple servers which are connected to a computer network to provide services for other computers, by using another computer.

As thus described, the server cooperation system according to the present invention is a system for achieving cooperation between service servers such as web sites via a network such as the Internet, by using cooperation modules created by third parties. The server cooperation system according to the present invention relates to a system, method and program for feeding back profits obtained through cooperation of multiple service servers to developers of cooperation modules and business entities running the service servers as incentives.

The server cooperation system according to the present invention provides cooperation between at least two service servers; the cooperation server for achieving cooperation between service servers includes: a business entity data storage means for storing business entity data of service servers; a cooperation module storage means for storing cooperation modules for achieving cooperation between the service servers; a developer data storage means for storing developer data of the cooperation modules; a cooperation history storage means for storing cooperation history data of the cooperation modules; and an incentive settlement means for calculating an amount of an incentive and performing paying of the incentive by referring to the business entity data, the developer data and the cooperation history data.

A client for using the service servers includes: a service information display means for displaying information acquired from the service servers; a cooperation module selection/execution means for performing selection and execution of the cooperation modules stored in the cooperation module storage means and controlling the service information display means; and a cooperation history transmission means for notifying the cooperation history storage means of the execution of the cooperation modules.

The client may further include a cooperation identification data transmission means transmitting cooperation identification data for identifying the executed cooperation modules to the service servers.

The service servers may further include an incentive data determination/notification means for determining incentive data by referring the cooperation identification data received from the cooperation identification data transmission means and transmitting the incentive data to the server cooperation system.

The cooperation server may further include an incentive amount storage means for storing the incentive data received from the incentive data determination/notification means.

The cooperation server may further include: an incentive condition presentation means storing incentive conditions presented by developers of the cooperation modules; an incentive condition storage means for storing the incentive condition; a presented condition notification means for notifying the incentive conditions to business entities of the service servers; and an incentive condition determination means for instructing whether the business entities of the service servers accept the incentive conditions.

An objective of the present invention is to provide an incentive-based server cooperation system which eliminates the need for providing an incentive payment function for the service servers for which cooperation is to be provided.

Another objective of the present invention is to provide an incentive-based server cooperation system with improved user convenience, in which various service server cooperation functions are provided by many cooperation modules.

Still another objective of the present invention is to provide an incentive-based server cooperation system which allows business entities who run cooperation source service servers to obtain incentives.

In the present invention, the cooperation server is provided with the function of paying incentives and this allows business entities who run service servers to pay incentives by only performing registration; this eliminates the need for providing an incentive payment function for the service servers for which cooperation is to be provided.

Also, the present invention facilitates the function of paying incentives by providing the function of paying incentives for the cooperation server; therefore the present invention promotes many service servers to pay incentives, and allows the developers of the cooperation modules to acquire incentives for the service servers. This promotes developments of many cooperation modules by giving incentives to the developers of the cooperation modules and results in provision of various service server cooperation functions by using many cooperation modules, improving the user convenience.

Furthermore, the present invention, in which the function of paying incentives is provided for the cooperation server to allow flexibly designing the settlement scheme of the incentive amounts, enables business entities who run cooperation source service servers to acquire incentives.

It should be noted that the above-described embodiments and examples may be combined in an actual implementation.

Although embodiments of the present invention are described in detail in the above, actual implementations of the present invention are not limited to the above-described embodiments; the present invention encompasses modifications within the scope of the present invention.

The present application claims the priority based on Japanese Patent application No. 2009-093871 and the disclosure of Japanese Patent application No. 2009-093871 is incorporated herein by reference.

1. An incentive-based server cooperation system, comprising:
a plurality of service servers;
a cooperation server configured to provide cooperation between said plurality of service servers; and
a client configured to use said respective service servers,
wherein said cooperation server includes:
a business entity data storage section which stores business entity data related to business entities of said respective service servers;
a cooperation module storage section which stores cooperation modules used for achieving cooperation between said service servers;
a developer data storage section which stores developer data related to developers of said cooperation modules;
a cooperation history storage section which stores cooperation history data of said cooperation modules; and
an incentive settlement section which performs calculation of amounts of incentives and payment of the incentives by referring said business entity data, said developer data and said cooperation history data, and
wherein said client is configured to display information acquired from said respective service servers to perform selection and execution of said cooperation modules stored in said cooperation module storage section, and to notify said cooperation history storage section of the execution of said cooperation modules. g

2. The incentive-based server cooperation system according to claim 1, wherein said client is configured to acquire information from any one of said service servers in response to an operation by a user, to display the acquired information on a screen, to display a list of said cooperation modules registered in said cooperation server in response to an operation by said user, to select one cooperation module from the list of said cooperation modules, to acquire the selected cooperation module from said cooperation module storage section, and to execute said acquired cooperation module,
wherein said cooperation modules are each configured to, when executed, extract predetermined information from the information already acquired from a service server which is a cooperation source,
wherein said client is configured to acquire information in response to control of said cooperation modules by transmitting necessary information to service servers which are cooperation destinations, to display the acquired information on the screen, and a cooperation function start button being pushed, to display web pages of web sites of said cooperation destinations on the screen of said client when execution of said cooperation modules is completed, to, when one of said cooperation modules is selected by said user, acquire said selected cooperation module from said cooperation server, and to notify said cooperation server of a fact that said selected cooperation module is executed, and
wherein said incentive settlement section is configured to record the fact notified thereto as a cooperation history, to calculate the amounts of the incentives at a predetermined timing, and to ask terminals of the financial institutions for withdrawal processes from accounts of said business entities and deposit processes to accounts of said developers after said amounts of the incentives are calculated.

5. The incentive-based server cooperation system according to claim 4, wherein said incentive settlement section is configured to distribute a total incentive amount configured for each of web sites of said cooperation destinations to the respective developers so that allocations to the developers are proportional to the number of uses of cooperation modules used for achieving cooperation to said each web site of said cooperation destinations, to calculate the allocations of said total incentive amounts for the web sites of all the cooperation destinations to transmit data used for calculation of an incentive amount for used one of said cooperation modules to said cooperation history storage section to record the data used for the calculation.

3. The incentive-based server cooperation system according to claim 2, wherein said incentive settlement section is configured to acquire past cooperation history from said cooperation history storage section, to acquire data necessary for settlement from said business entity data storage section and said developer data storage section, to calculate amounts of incentives in accordance with a predetermined method, and to perform processes related to withdrawal from and deposit to accounts of financial institutions to perform payment of incentives from said business entities to said developers.

4. The incentive-based server cooperation system according to claim 3, wherein each of said service servers provides a web site,
wherein said cooperation modules are configured to extract a character string related to predetermined contents from contents of a web page of a web site of said cooperation source, and to perform a generation process of a URL for displaying a web page which is one of web pages of web sites of said cooperation destinations, and is related to said extracted character string,
wherein said client is configured to display the list of said cooperation modules on the screen in response to, and to calculate an amount of an incentive to be received by each of said developers.

6. The incentive-based server cooperation system according to claim 4, wherein said cooperation history storage section is configured to store data indicating used cooperation modules, to store URLs of web sites of cooperation sources, and to store URLs of web sites of cooperation destinations, and
wherein said incentive settlement section is configured to, in any of cases when any of the URLs of the web sites of said cooperation sources match a cooperation source URL set in said business entity data and when any of the URLs of the web sites of said cooperation destinations match a cooperation destination URL set in said business entity data, calculate the amounts of the incentives based on unit prices configured for the matching URLs in a settlement process.

7. The incentive-base server cooperation system according to claim 4, wherein said incentive settlement section is configured to sort a display order of the list of said cooperation modules displayed on the screen of said client when the cooperation function start button is pushed, according to the unit prices configured in said business entity data by the business entities of the web sites for which cooperation is achieved by said cooperation modules.

8. The incentive-based server cooperation system according to claim 4, wherein said incentive settlement section is configured to distribute a total incentive amount configured for each of web sites of said cooperation destinations to business entities of the web sites of said cooperation sources so that allocations to the business entities of the web sites of said cooperation sources are proportional to the number of transfers from said web sites of cooperation sources to said each web site of said cooperation destinations, to calculate the allocations of said total incentive amounts for the web sites of all the cooperation destinations, and to calculate total incentive amounts indicating balances of income and outgoing of business entities of respective web sites.

9. The incentive-based server cooperation system according to claim 4, wherein said incentive settlement section is configured to distribute a total incentive amount configured for each of web sites of said cooperation destinations in a settlement process in accordance with ratios of the number of transfers from said web sites of cooperation sources and total incentive amounts configured by business entities of said web sites of cooperation sources.

10. A cooperation server used in an incentive-based server cooperation system including a plurality of service servers and a client configured to use said service servers, said cooperation server comprising:
a business entity data storage section which stores business entity data related to business entities of said respective service servers;
a cooperation module storage section which stores cooperation modules used for achieving cooperation between said service servers;
a developer data storage section which stores developer data related to developers of said cooperation modules;
a cooperation history storage section which stores cooperation history data of said cooperation modules; and
an incentive settlement section which performs calculation of amounts of incentives and payment of the incentives by referring said business entity data, said developer data and said cooperation history data.

11. A client used in an incentive-based server cooperation system including a plurality of service servers and a cooperation server configured to provide cooperation between said plurality of service servers, said cooperation server including:
a business entity data storage section which stores business entity data related to business entities of said respective service servers;
a cooperation module storage section which stores cooperation modules used for achieving cooperation between said service servers;
a developer data storage section which stores developer data related to developers of said cooperation modules;
a cooperation history storage section which stores cooperation history data of said cooperation modules; and
an incentive settlement section which performs calculation of amounts of incentives and payment of the incentives by referring said business entity data, said developer data and said cooperation history data, said client comprising:
a service information display section which displays information acquired from said respective service servers;
a cooperation module selection/execution section which performs selection and execution of said cooperation modules stored in said cooperation module storage section; and
a cooperation history transmission section which notifies said cooperation history storage section of the execution of said cooperation modules.

12. An incentive-based server cooperation method, comprising:
in a cooperation server for achieving cooperation between a plurality of service servers, storing business entity data related to business entities of said respective service servers in a business entity data storage section;
storing cooperation modules used for achieving cooperation between said service servers in a cooperation module storage section in the cooperation server;
storing developer data related to developers of said cooperation modules in a developer data storage section in the cooperation server;
storing cooperation history data of said cooperation modules in a cooperation history storage section in the cooperation server;
performing calculation of amounts of incentives and payment of the incentives by referring said business entity data, said developer data and said cooperation history data by the cooperation server;
by a client configured to use said respective service servers, displaying information acquired from said respective service servers;
performing selection and execution of said cooperation modules stored in said cooperation module storage section by the client; and
notifying said cooperation history storage section of the execution of said cooperation modules by the client.

13. The incentive-based server cooperation method according to claim 12, said method comprising:
acquiring information from any one of said service servers in response to an operation by a user, by said client;
displaying the acquired information on a screen by the client;
displaying a list of said cooperation modules registered in said cooperation server in response to an operation by said user, by the client;
selecting one cooperation module from the list of said cooperation modules by the client;
acquiring the selected cooperation module from said cooperation module storage section by the client;
executing said acquired cooperation module by the client;
when said cooperation modules are executed, extracting predetermined information from the information already acquired from a service server which is a cooperation source by the client;
controlling said service information display section as predetermined for each of the cooperation modules by the client;
acquiring information in response to control of said cooperation modules by transmitting necessary information to service servers which are cooperation destinations, by the client;
displaying the acquired information on the screen by the client; and
transmitting data used for calculation of an incentive amount for used one of said cooperation modules to said cooperation history storage section to record the data used for the calculation, by the client.

14. The incentive-based server cooperation method according to claim 13, said method comprising:
acquiring past cooperation history from said cooperation history storage section in said cooperation server;
acquiring data necessary for settlement from said business entity data storage section and said developer data storage section in said cooperation server;
calculating amounts of incentives in accordance with a predetermined method in said cooperation server; and
performing processes related to withdrawal from and deposit to accounts of financial institutions to perform payment of incentives from said business entities to said developers, by said cooperation server.

15. The incentive-based server cooperation method according to claim 14, further comprising:
executing said cooperation modules in said client;
extracting a character string related to predetermined contents from contents of a web page of a web site of each of said cooperation sources by the client;
performing a generation process of an URL for displaying a web page related to said extracted character string selected from web pages of a web site of each of said cooperation destinations in the client;
displaying the list of said cooperation modules on the screen in response to a cooperation function start button being pushed, in the client;
displaying web pages of web sites of said cooperation destinations on the screen of said client when execution of said cooperation modules is completed, in the client;
when one of said cooperation modules is selected by said user, acquiring said selected cooperation module from said cooperation server by the client;
notifying said cooperation server of a fact that said selected cooperation module is executed, by the client;
recording the fact notified thereto as a cooperation history in said cooperation server;
calculating the amounts of the incentives at a predetermined timing in said cooperation server; and
asking the financial institutions for withdrawal processes from accounts of said business entities and deposit processes to accounts of said developers by the cooperation server, after said amounts of the incentives are calculated.

16. The incentive-based server cooperation method according to claim 15, further comprising:
by said cooperation server, distributing a total incentive amount configured for each of web sites of said cooperation destinations to the respective developers so that allocations to the developers are proportional to the number of uses of cooperation modules used for achieving cooperation to said each web site of said cooperation destinations;
calculating the allocations of said total incentive amounts for the web sites of all the cooperation destinations, by said cooperation server; and
calculating an amount of an incentive to be received by each of said developers, by said cooperation server.

17. The incentive-based server cooperation method according to claim 15, said method comprising:
storing data indicating used cooperation modules in said cooperation history storage section in said cooperation server;
storing URLs of web sites of cooperation sources in said cooperation history storage section in said cooperation server;
storing URLs of web sites of cooperation destinations in said cooperation history storage section in said cooperation server; and
by said cooperation server, in any of cases when any of the URLs of the web sites of said cooperation sources match a cooperation source URL set in said business entity data and when any of the URLs of the web sites of said cooperation destinations match a cooperation destination URL set in said business entity data, calculating the amounts of the incentives based on unit prices configured for the matching URLs in a settlement process.

18. The incentive-based server cooperation method according to claim 15, further comprising:
by said cooperation server, sorting a display order of the list of said cooperation modules displayed on the screen of client when the cooperation function start button is pushed, according to the unit prices configured in said business entity data by the business entities of the web sites for which cooperation is achieved by said cooperation modules.

19. The incentive-based server cooperation method according to claim 15,
by said cooperation server, distributing a total incentive amount configured for each of web sites of said cooperation destinations to business entities of the web sites of said cooperation sources so that allocations to the business entities of the web sites of said cooperation sources are proportional to the number of transfers from said web sites of cooperation sources to said each web site of said cooperation destinations;
calculating the allocations of said total incentive amounts for the web sites of all the cooperation destinations by said cooperation server; and
calculating total incentive amounts indicating balances of income and outgoing of business entities of respective web sites by said cooperation server.

20. The incentive-based server cooperation method according to claim 15, further comprising:
by said cooperation server, distributing a total incentive amount configured for each of web sites of said cooperation destinations in a settlement process in accordance with ratios of the number of transfers from said web sites of cooperation sources and total incentive amounts configured by business entities of said web sites of cooperation sources.

21. A non-transitory recording medium storing a program which when executed causes a cooperation server used in an incentive-based server cooperation system including a plurality of service servers and a client configured to use said service servers to perform a method comprising steps of:
storing business entity data related to business entities of said respective service servers in a business entity data storage section in said cooperation server;
storing cooperation modules used for achieving cooperation between said service servers in a cooperation module storage section in said cooperation server;
storing developer data related to developers of said cooperation modules in a developer data storage section in said cooperation server;
storing cooperation history data of said cooperation modules in a cooperation history storage section in said cooperation server;
performing calculation of amounts of incentives and payment of the incentives by referring said business entity data, said developer data and said cooperation history data.

22. A non-transitory recording medium storing a program which when executed causes a client used in an incentive-based server cooperation system to perform a method, said incentive-based server cooperation system including a plurality of service servers and a cooperation server configured to provide cooperation between said plurality of service servers, said cooperation server including:
a business entity data storage section which stores business entity data related to business entities of said respective service servers;
a cooperation module storage section which stores cooperation modules used for achieving cooperation between said service servers;
a developer data storage section which stores developer data related to developers of said cooperation modules;
a cooperation history storage section which stores cooperation history data of said cooperation modules; and
an incentive settlement section which performs calculation of amounts of incentives and payment of the incentives by referring said business entity data, said developer data and said cooperation history data,
said method comprising steps of:
displaying information acquired from said respective service servers;
performing selection and execution of said cooperation modules stored in said cooperation module storage section; and
notifying said cooperation history storage section of the execution of said cooperation modules.
